(19) United States
(12) Patent Application Publication
(10) Pub. No.: US 2007/0133651 A1
(43) Pub. Date: Jun. 14, 2007

(54) Method for controlling foaming of slag in an electric arc furnace

(76) Inventors: Ronald E. Gerhan, Avon Lake, OH (US); Nicolas Lugo, Clarksville, TN (US); Theodore J. Kurela, Hinckley, OH (US)

Correspondence Address: WADDEY & PATTERSON, P.C., 1600 DIVISION STREET, SUITE 500, NASHVILLE, TN, 37203, US

(21) Appl. No.: 11/300,688

(22) Filed: Dec. 14, 2005

(51) Int. Cl. F27D 17/00

(52) U.S. Cl. 373/9

(57) ABSTRACT

A method for controlling the foaming of slag in an electric arc furnace is disclosed. The furnace comprises at least one electrode column. Current is applied to the electrode column, causing an arc to form between the tip of the electrode column and the scrap, melting the scrap. Impurities in the molten scrap metal rise to the surface forming slag. A meter determines the total harmonic distortion associated with the system. If the total harmonic distortion is greater than a predetermined set point, and the scrap metal is sufficiently molten, then a foaming agent is added thereto.

### BACKGROUND OF THE INVENTION

1. Technical Field

The present invention relates to a method for increasing the efficiency of the operation of an electric arc furnace (EAF), and, more particularly, to controlling the foaming of slag so as to better control the arc and minimize the total harmonic distortion of the system.

2. Background Art

In the steel industry, graphite electrodes are used in electrothermal furnaces, sometimes called electric arc furnaces (EAFs), to melt metals and other ingredients to form steel. A series of electrodes are joined end-to-end to form an electrode column. Heat needed to melt the metals is generated by passing current through the electrode column, which causes an arc to form between the electrode column and the metals in the furnace. Typically, the furnace comprises three electrode columns. Electrical currents in excess of seventy thousand amperes are often used. The resulting high temperature melts the metals and other ingredients.

For every melting stage, there is an optimum arc length and it works in conjunction with the type of charge material (i.e., metals in the furnace), power input and other electric arc furnace parameters to determine the meltdown rate. It is extremely important to control the arc and its length. For example, when an arc moves excessively, it can cause the electrode column from which it extends to jerk; excessive jerking of the electrode column can cause the electrode column to break and fall into the furnace. Electrodes are one of the highest costs associated with furnace operation; therefore, it is of utmost importance to the furnace operator to control the arc and thus minimize electrode consumption and waste. Further, when a portion of an electrode column falls into the furnace, it becomes an added impurity to the molten steel and undesirably decreases the steel's purity level.

Additionally, erratic movement of the electrode column, which can be caused by erratic arc movement, increases power consumption and, in turn, increases furnace operational costs.

Each “heat,” the common name for one full-cycle of operation of the electric arc furnace, comprises various stages. During the initial stage, sometimes referred to as the bore-down stage, the scrap is cold and has a large surface area. When current is applied to the electrode columns and they are lowered so as to touch the scrap metal, each electrode column eventually creates a hole in the scrap. During this stage, when current is applied to the electrode column and the arc forms, the arc moves wildly and jumps to different large surface pieces of scrap metal.

After the bore-down is complete, the meltdown stage begins. During this stage, there is high power consumption and a relatively long arc. The main objective during the meltdown stage is to force the maximum amount of electrical energy through the electrode columns quickly to produce the hottest possible arc. During this stage, the arc continues to move wildly, contacting the uppermost pieces of scrap metal in the furnace.

During the bore down and early meltdown stages, the operator does not actively control the arc unless it is, for example, flaring to and/or contacting the furnace sidewall and causing excessive damage to the furnace sidewall.

When the scrap metal lies in relatively molten state, which usually occurs during the refining stage (but the stage can vary depending on the furnace's operational characteristics and the user's melting practices), there is no scrap to protect the furnace sidewall, so it is necessary to switch to a lower power setting. This delivers adequate process energy while generally shortening the arc to protect the furnace walls.

When the scrap is sufficiently melted, i.e., generally during the refining stage of the “heat,” the impurities in the molten steel bath rise to the surface and form a slag. It is extremely important during this time for the furnace operator to control the slag because it can be used to control the arc and increase electric arc furnace's operational efficiencies. After refining, the furnace is “tapped;” that is, the molten steel is removed from the furnace for further processing and to permit another heat to commence.

It is known to add a foaming agent such as carbon, coke or graphite powder to the slag. The foaming agent combines with oxygen in the furnace to generate carbon monoxide (CO), which causes the slag to foam. Generally, an injection lance is used to inject the foaming agent into the slag.

Foaming of the slag, when properly maintained, provides tremendous benefits to operation of the electric arc furnace. For example, it greatly reduces heat loss to the sidewall of the furnace. It also channels heat transfer from the electric arc to the molten steel thereby providing for higher rates of energy input, reduced power and voltage fluctuations, reduced electrical and audible noise and increase arc length without increasing heat loss, electrode consumption or refractory consumption.

However, addition of a foaming agent to the slag can be detrimental to the overall performance of the system, if, for example, too much is added or if the timing is poor. For instance, if a carbon-based foaming agent is added too soon, the carbon may not readily combine with existing oxygen in the system to form CO but rather carbon particulates may fall into the molten steel and become an added impurity. Also, if too much foaming agent is added, it can cause the slag to foam out of the furnace undesirably.

When the scrap metal is sufficiently molten, i.e., generally during the refining stage, the furnace operator is busy evaluating the molten steel ensuring that variables associated with the melt are suitable. For example, the operator typically checks the power consumption, the temperature of the molten steel, the molten steel's chemical make-up and the off-gas content. Then, he is focused on tapping the furnace so that a new heat may begin.

Given the impact of foamy slag on the overall operation of the furnace, it is extremely important that it be properly controlled. To date, furnace operators depend on various factors to indicate when to add a foaming agent. For example, the operator will usually add foaming agent if he sees the electrode column jerking or moving erratically or, after listening to the furnace, believes that it is making “too much” noise. These two factors are subjective and different operators will, obviously, draw different conclusions. Given the subjectivity of the criteria, there is a need for a simple and effective evaluation of objective criteria to determine if foaming agent should be added to the slag.

U.S. Pat. No. 6,584,137 to Dunn et al. teaches a method to automate the foaming of slag, so as to standardize furnace operation and lessen the necessity of a furnace operator to rely on subjective criteria to control the furnace. Specifically, Dunn et al. teaches injecting carbon into the electric arc furnace, either manually or automatically, as the modes of operation of inputting exothermic energy into the steel melt proceed. That is, carbon may be injected at a low rate manually or automatically during the second operating mode of exothermic energy input as required for slag foaming and melt-in carbon control, and the carbon may be injected—either automatically or manually—at a higher rate during the third operating mode of inputting exothermic energy, as required for slag foaming and decarbonization of the steel melt. While the method taught by Dunn et al. has many advantages, it is more desirable to control the foaming of slag based on different furnace parameters.

What is desired, therefore, is a method of automatically determining if it is necessary to add a foaming agent to the slag when the scrap metal is sufficiently molten based on an objective evaluation of a predetermined furnace parameter and without the need for evaluation of any subjective criteria by the furnace operator, which automatically completes the task of adding the foaming agent without further involvement by the furnace operator, and which continuously monitors the furnace operating parameter and automatically adds foaming agent when necessary.

### SUMMARY OF INVENTION

It is an aspect of the present invention to provide an improved method for stabilizing an arc in an electric arc furnace.

It is another aspect of the present invention to provide objective criterion to determine when it is necessary to stabilize the arc.

It is still another aspect of the present invention to provide an automated method for stabilizing the arc in an electric arc furnace based on an evaluation of the objective criterion.

It is yet another aspect of the present invention to provide an automated process for causing foaming agent to be added to the slag so as to stabilize the arc, when the objective criterion indicates that foaming slag is desirable.

These aspects and others, which will become apparent to the artisan upon review of the following description, can be accomplished by providing a method for making steel in an electric arc furnace, the electric arc furnace having a plurality of electrode columns movable into and out of the furnace, the furnace containing scrap metal to be melted, the scrap metal having impurities therein and the furnace further comprising a lance which extends through a furnace sidewall.

The method comprises the steps of applying current to each electrode column so as to cause an arc to form between the base of each electrode column and the scrap metal, which current is high enough to cause the scrap metal to melt, causing impurities in the molten scrap metal to rise to the surface thereof and form a slag. A meter measures the total amount of electrical energy and electrical harmonics that have been applied to the electrode columns by evaluating the current applied. A comparator determines if the actual amount of electrical energy and harmonic levels that have been applied are greater than predetermined set points so as to ensure that the heat is in a condition to accept initiation of slag foaming.

If the total harmonic distortion is greater than a predetermined set point, and the scrap metal is sufficiently molten, then the system automatically adds a predetermined amount of foaming agent through the lance to the slag so as to stabilize the arc. Optionally, the user may cause the foaming agent to be added for a predetermined amount of time (such as for about ten seconds) and/or may cause the system to periodically and/or continuously monitor the total harmonic distortion to determine if the actual total harmonic distortion is greater than the predetermined set point and add a predetermined amount of foaming agent, as desired.

In another preferred embodiment, the operator can, using a manual control on his control panel, be alerted, by, for example, an alarm or some other signal, to the fact that the total harmonic distortion is greater than the predetermined set point and that the melt is sufficiently liquid. When the alarm sounds, the operator may manually cause foaming agent to be added to the slag.

It is to be understood that both the foregoing general description and the following detailed description provide embodiments of the invention and are intended to provide an overview or framework of understanding of the nature and character of the invention as it is claimed. The accompanying drawings are included to provide a further understanding of the invention and are incorporated in and constitute a part of the specification. The drawings, together with the description, serve to describe the principles and operations of the invention.

### BRIEF DESCRIPTION OF THE DRAWINGS

The structure and preferred embodiments of the invention can best be understood by reference to the accompanying drawings, in which:

FIG. 1 is a schematic representation of an electric arc furnace constructed in accordance with the present invention; and

FIG. 2 is a flow chart illustrating the steps for controlling the foaming of slag in the electric arc furnace of FIG. 1.

### DETAILED DESCRIPTION OF THE PREFERRED EMBODIMENT

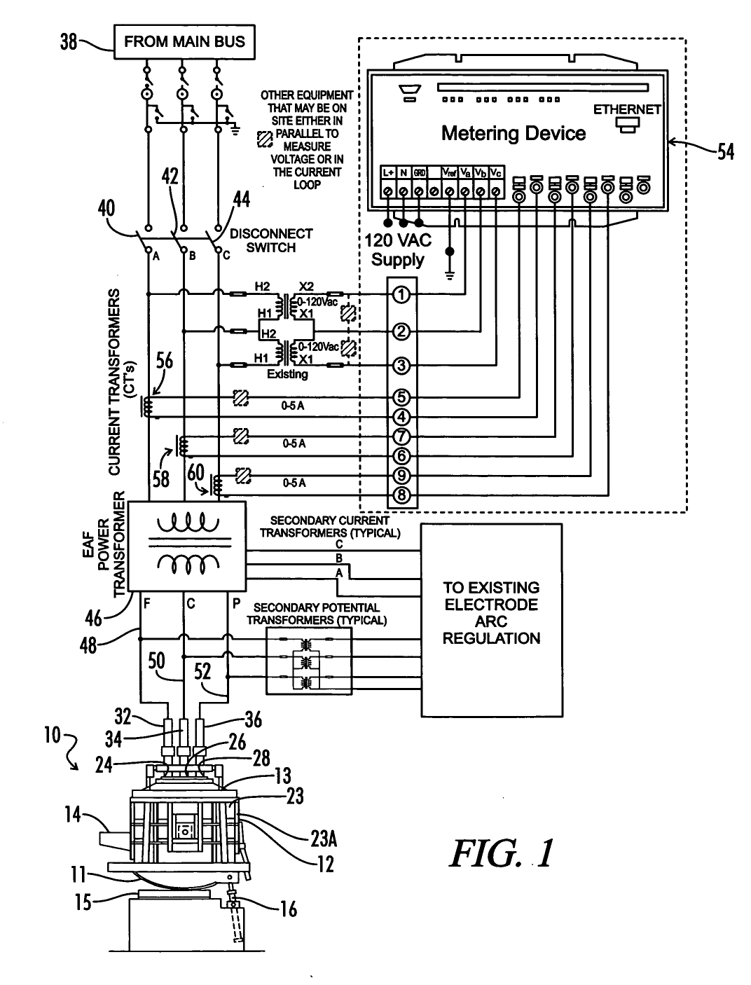

Referring in detail to FIG. 1, a conventional AC electrothermal furnace or electric arc furnace (EAF) is shown and designated by the reference numeral 10. The furnace 10 is generally cylindrical in shape and has a generally rounded bottom 11. The furnace 10 further comprises sidewall 12 extending between bottom 11 and roof 13. Although the invention herein is described with reference to an AC EAF furnace, the invention may also be used with a DC EAF furnace with a different electrical arrangement. In either case, the bottom 11 is refractory lined and the sidewall 12 is generally refractory lined to above the slag line, that is, the level in the furnace 10 to where slag normally rises. The furnace 10 has a taphole/spout 14. The EAF 10 rests on a rocker rail 15 and is capable of being titled by hydraulic cylinders 16 to pour the molten metal from the furnace 10 through spout 14.

Water-cooled panels 23 supported by a water-cooled cage 23A extend above the slag line of sidewall 12. The furnace roof 13 has electrode ports 24, 26, 28 through which electrode columns 32, 34, 36 extend into the furnace 10.

Graphite electrode columns 32, 34, 36 are used in furnace 10 to melt metals and other ingredients to form steel. Electrode columns 32, 34, 36 are supported by known electrode holders (not shown), which are connected to electrode mast arms (not shown), connected in turn to electrode masts (also not shown).

The heat needed to melt the scrap metal is generated by passing current through one or more of the electrode columns 32, 34, 36 and forming an arc between the base area of the electrode column(s) and the metal in the furnace. The resulting high temperature melts the metals and other ingredients.

Referring again to FIG. 1, as is known, current traveling to each electrode column 32, 34, and 36 travels from the main bus 38. Generally, for safety reasons, electric arc furnace 10 has one disconnect switch per phase 40, 42, 44 to automatically disconnect the power supply, as desired.

An EAF power transformer 46 is positioned between the disconnect switches 40, 42, 44 and the three electrode columns 32, 34, 36 that are positioned in the furnace 10. As is known, the power transformer 46 takes the high voltage/low current coming into the furnace 10 and steps it down to low voltage/high current suitable to provide the high amperage needed to pass through the electrode columns 32, 34, 36 to melt the scrap metal. In viewing FIG. 1, it should be understood that based on the orientation therein, the “primary” side of the furnace's electrical circuit refers to the voltage lines, switches, etc. that are positioned “above” the EAF power transformer 46; in contrast, anything positioned “below” the EAF power transformer 46 is deemed to be on the “secondary” side.

As is known, most AC electric arc furnaces 10 are powered by 3-phase power lines 48, 50, and 52 carrying about forty thousand volts and one thousand amps on the primary side of the transformer and more than seventy thousand amps on the secondary side. Conventionally, one phase 48 is deemed the floor phase (F), one phase 50 is deemed the center phase (C); and one phase 52 is deemed the pit phase (P).

A meter 54 is connected on the primary side of the furnace 10 electrical circuit and reads the harmonic distortion associated with an individual phase of current such as 48. The same meter measures the harmonic distortion associated with the other two phases 50, 52, respectively. Total harmonic distortion, which is the collective and interactive distortion of the individual single phase distortion, is determined from these readings. Any suitable metering device may be used, including a metering device sold by Electro Industries under the tradename NEXUS 1250.

Common to every electric arc furnace are two sets of electrical metering transformers located on the primary side of the EAF power transformer. One set of electrical metering transformers is known as potential transformers (PTs) and converts the high incoming primary voltage to a safe, measurable voltage. A common PT transformation is 34500 volts to 115 volts. There is one PT associated with each pair of electrical phases. As shown in FIG. 1, one PT is connected between phases 48 and 50. The second PT is connected between phases 50 and 52. The third PT is connected between phases 52 and 48, and gives a proportional voltage associated between phases. There are other methods of connecting PTs that furnace manufacturers may use, but the resulting signals are essentially the same; in any event, any method known in the art may be used. The metering device is connected to and reads the three proportional 115 volts PT signals.

A second set of electrical metering transformers are known as current transformers (CTs) 56, 58, 60 and converts the incoming primary current to a safe, measurable current. A common CT transformation is 2000 amps to five amps. There is commonly one CT associated with each electrical phase (48, 50, 52). However, some furnaces physically have only two CTs (the missing CT value can be determined in a manner known in the art). The metering device is connected to and reads the three proportional five amp CT signals. It is through the measurement of these six signals that the meter can determine in a manner known in the art the individual phase harmonic distortion as well as the total harmonic distortion.

The system of the present invention can be used in either a manual mode or an automatic mode. In the automatic mode, the system can be designed to continuously monitor the parameter-of-interest, i.e., the total harmonic distortion, and inject a foaming agent, as desired, or it can monitor the total harmonic distortion only after being manually activated by the operator.

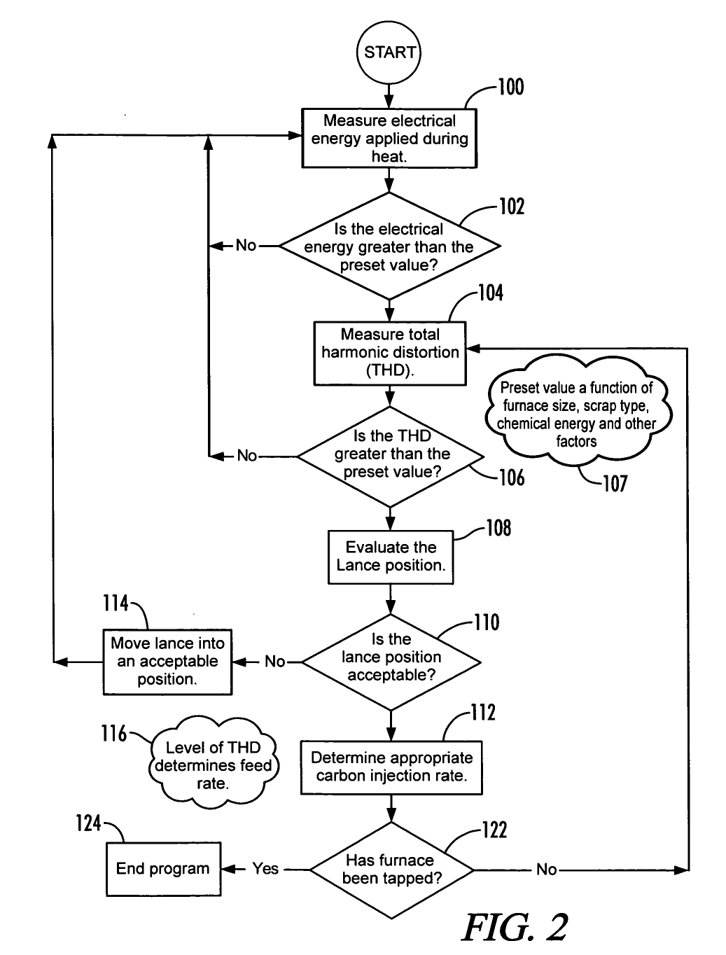

FIG. 2 is a flow chart illustrating the method for determining the necessity of and timing for adding foaming agent to an electric arc furnace. The method generally comprises the following steps. First, scrap metal to be melted is placed in the electric arc furnace. The scrap metal has impurities therein. At least one electrode column is moveable into and out of the electric arc furnace, is positioned near the scrap metal. Current is applied to the electrode column so as to cause an arc to form between the electrode column and the scrap metal, which arc causes the scrap metal to melt. Impurities in the molten scrap metal rise to the surface thereof to form a slag.

Referring specifically to FIG. 2, meter 54 (FIG. 1) measures the electrical energy associated with this heat at 100. This step ensures that the heat is in a suitable liquid condition. It is only during this stage that the conditions are proper for the added carbon to combine with oxygen to create CO and cause the slag to foam. If the foaming agent is injected earlier in the heat, it will not reach the slag and will be ineffective. Typically, the suitable liquid condition can occur after approximately 70% of the total energy required is reached for each charge. Therefore, if the system determines that the energy required is more than a preset value at 102, then it advances to the next step. If it is less, then the system returns to 100.

Referring still to FIG. 2, the system measures the harmonic distortion of the current associated with the electrode column to which it is assigned, such as 32 (FIG. 1). Then at 104, the system determines the total harmonic distortion. Then the system determines if the total harmonic distortion is greater than a predetermined set point at 106. The system can be designed with any predetermined set point, but preferably, the system determines if the total harmonic distortion is greater than about 5%. The exact set point will vary with each furnace, and will depend on various factors, including but not limited to the user's furnace operational characteristics, melting practices, furnace size, scrap type and chemical energy as shown at 107.

If the total harmonic distortion is greater than the predetermined set point, then the system advances to 108 to assess the position of the carbon injection lance. If at 110 it is determined that the lance is in an unacceptable position, then the lance must be adjusted, either manually or by computer, as is known in the field, to an acceptable position at 114. If the lance is in an acceptable position at 110, then the system calculates an appropriate foaming agent feed rate at 112. As shown at 116, the level of the total harmonic distortion (THD) determines the feed rate.

The foaming agent may be added at any desirable rate, but preferably at a rate of about 40 kilograms per minute (for a 100 ton furnace, for example). The foaming agent feed rate is a function of the magnitude of the difference between the actual total harmonic distortion and the total harmonic distortion reference.

Any suitable foaming agent known in the art may be used, but typically carbon, coke or graphite powder is used. However, for certain steel making conditions optimum foaming may also be obtained by the additional use of lime and/or MgO. Combinations of these agents may also be used, as is known in the art.

The system determines if the furnace has been tapped at 122 and, if so, ends at 124. If the furnace 10 (FIG. 1) has not been tapped, then the system proceeds to monitor itself again, beginning at 104 (FIG. 2), until the furnace has been tapped.

In another preferred embodiment, the system could allow the total harmonic distortion to be displayed on a monitor and operatively connected to a visual or auditory alarm, for example, that notifies the operator that the proper conditions exist for the foaming agent to be added. Then after using his or her best judgment and/or some evaluation of subjective criteria, the operator could manually instruct that foaming agent to be added to the system.

In another preferred embodiment, the system could allow the foaming agent to be added for a predetermined period of time, such as about ten seconds, after the total harmonic distortion exceeds a predetermined set point.

In another preferred embodiment, a multi-point foaming agent injection site could be created based on the per phase total harmonic distortion (THD).

It should be understood that the system of the present invention optimizes electric arc furnace operation by allowing the operator control over the foaming of the slag based on objective criterion, rather than subjective criteria. As a result, the system will perform more uniformly over a period of time. Maintaining foaming slag will reduce heat loss to the sidewall of the furnace, minimize power and voltage fluctuations, reduce electrical and audible noise, and increase arc length without increasing heat loss, electrode consumption or refractory consumption.

This method of controlling foamy slag can be adapted for use with DC electric arc furnaces. In a DC EAF, the injection of the foaming agent could be determined by measuring the DC voltage fluctuations.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A method for making steel in an electric arc furnace, the electric arc furnace containing scrap metal to be melted, the scrap metal having impurities therein, the method comprising the following steps:
providing at least one electrode column moveable into and out of the electric arc furnace;
applying current to the electrode column so as to cause an arc to form between the electrode column and the scrap metal, which arc causes the scrap metal to melt, wherein the impurities in the molten scrap metal rise to the surface thereof to form a slag, the applied current causing at least some harmonic distortion;
determining a total harmonic distortion value from the at least some harmonic distortion;
determining if the total harmonic distortion value is greater than a predetermined set point; and
adding at least one foaming agent to the slag if the total harmonic distortion value is greater than the predetermined set point.

2. The method of claim 1, further comprising the step of automatically adding foaming agent to the slag if the total harmonic distortion value is greater than the predetermined set point.

3. The method of claim 2, determining the amount of current that has been applied to the at least one electrode and from that determining a total amount electrical energy that has been applied to the furnace, then determining if the total amount of electrical energy is greater than a predetermined amount.

4. The method of claim 3, adding foaming agent to the slag if the total amount electrical energy that has been applied is greater than the predetermined amount.

5. The method of claim 2, further comprising the step of providing a lance through which the foaming agent may be added to the slag.

6. The method of claim 5, further comprising the step of determining if the lance is a predetermined proper position.

7. The method of claim 6, further comprising the step of adding foaming agent to the slag if the lance is in the predetermined proper position.

8. The method of claim 1, further comprising the step of manually adding foaming agent to the slag if the total harmonic distortion value is greater than the predetermined set point.

9. The method of claim 8, wherein the foaming agent comprises carbon, coke, graphite powder, lime, MgO or a combination thereof.

10. A method for foaming slag in an electric arc furnace containing scrap metal, the method comprising the following steps:
providing at least one electrode column moveable into and out of the electric arc furnace;
applying current to the electrode column so as to cause an arc to form between the electrode column and the scrap metal, which current is high enough to cause the scrap metal to melt, wherein the impurities in the molten scrap metal rise to the surface thereof to form a slag, wherein the applied current causes at least some harmonic distortion from which an amount of total harmonic distortion may be determined, wherein an amount of total electrical energy may be determined from the current applied;
determining the total harmonic distortion;
determining if the total harmonic distortion is greater than a predetermined set point;
determining the total electrical energy;
determining if the total electrical energy is greater than a predetermined set point;
providing a lance movable into and out of an appropriate position;
determining if the lance is in an appropriate position; and
adding a foaming agent through the lance to the slag if the total harmonic distortion is greater than the predetermined set point, the total electrical energy is greater than a predetermined set point, and the lance is in the appropriate position.

11. The method of claim 10, further comprising the step of automatically adding foaming agent to the slag.

12. The method of claim 10, further comprising the step of adding foaming agent to the slag for a predetermined amount of time.

13. The method of claim 12, further comprising the step of adding the foaming agent to the slag for about ten seconds.

14. The method of claim 10, further comprising the step of periodically and automatically monitoring the total harmonic distortion.

15. The method of claim 14, further comprising the step of continuously and automatically monitoring the total harmonic distortion.

16. The method of claim 10, wherein the foaming agent comprises carbon, coke, graphite powder, lime, MgO or a combination thereof.

17. The method of claim 10, further comprising the step of manually adding foaming agent to the slag.
